(19) United States
(12) Patent Application Publication
(10) Pub. No.: US 2018/0032882 A1
(43) Pub. Date: Feb. 1, 2018

(54) METHOD AND SYSTEM FOR GENERATING RECOMMENDATIONS BASED ON VISUAL DATA AND ASSOCIATED TAGS

(71) Applicant: FUJI XEROX CO., LTD., Tokyo (JP)

(72) Inventors: Dhiraj Joshi, Ossining, NY (US); Matthew L. Cooper, San Francisco, CA (US); Francine Chen, Menlo Park, CA (US); Yin-Ying Chen, Sunnyvale, CA (US)

(21) Appl. No.: 15/220,833

(22) Filed: Jul. 27, 2016

(51) Int. Cl. G06N 5/04; G06N 7/00; G06N 99/00

(52) U.S. Cl. CPC G06N 5/04; G06N 99/005; G06N 7/005

(57) ABSTRACT

A method and system for generating recommendations. The method including extracting concept information from visual content associated with content posted to a social media platform, detecting one or more preferences based on the extracted concept information, generating a matrix based on the detected one or more preferences, calculating a first similarity between the one or more preferences associated with a first user and one or more preferences associated with a second user based on the generated matrix, and generating a recommendation based on the matrix and the calculated first similarity.

### BACKGROUND

### Field

The present disclosure relates to social media networks, and more specifically, to systems and methods of using social media networks to generate recommendations.

### Related Art

In related art systems, social media posts (e.g., content posted to TWITTER, FACEBOOK, INSTAGRAM, etc.) may be used to provide a user with recommendations associated with the posts. Recommendations could be in the form of social groups, products, books, movies, or venues to visit. Such related art recommender systems often incorporate a form of collaborative filtering to make recommendations to users. Collaborative filtering is a process of making recommendations to a user based on how the user had ranked or selected items in the past, and how other users have similarly ranked or selected items. For example, a related art recommender system may determine that User A likes action movies and science fiction movies based on viewing habits or social media posts. Further, the recommender system may also determine that other users (e.g., User B and User C) also like action movies and science fiction movies, similar to User A. If the recommender system determines the other users (e.g., User B and User C) like a new movie (e.g., Movie X), the related art recommender system may then recommend Movie X to User A.

However, one challenge with such related art is the so-called “cold-start” problem, in which the system is unable to suggest suitable recommendations for a new user (e.g., a user who has not yet watched enough movies or bought enough products for the system to make recommendations). Some related art item attribute-based recommendation systems may try to address this problem by extracting content features from items (e.g., director, actors for movies, author, genre for books etc.). Additionally, some related art systems may also use side information (such as age, gender, friends, etc.) acquired from a user to enhance collaborative filtering. However, there may still be a need for improving recommendations for new users by looking at additional media available on social media networks today.

### SUMMARY

Aspects of the present application may include a method of generating recommendations. The method includes extracting concept information from visual content associated with content posted to a social media platform, detecting one or more preferences based on the extracted concept information, generating a matrix based on the detected one or more preferences, calculating a first similarity between the one or more preferences associated with a first user and one or more preferences associated with a second user based on the generated matrix, and generating a recommendation based on the matrix and the calculated first similarity.

Further aspects of the present application may include a non-transitory computer readable medium having stored therein a program for making a computer execute a method of generating recommendations. The method includes extracting concept information from visual content associated with content posted to a social media platform, detecting one or more preferences based on the extracted concept information, generating a matrix based on the detected one or more preferences, calculating a first similarity between the one or more preferences associated with a first user and one or more preferences associated with a second user based on the generated matrix, and generating a recommendation based on the matrix and the calculated first similarity.

Additional aspects of the present application may include a server apparatus having a memory and a processor. The memory may store content posted to a social media platform. The processor may execute a process including extracting concept information from visual content associated with content posted to a social media platform, detecting one or more preferences based on the concept information, generating a matrix based on the detected one or more preferences, calculating a first similarity between the one or more preferences associated with a first user and one or more preferences associated with a second user based on the generated matrix, and generating a recommendation based on the matrix and the calculated first similarity.

Still further aspects of the present application may include a server apparatus. The server apparatus may include means for storing content posted to a social media platform, means for extracting concept information from visual content associated with content posted to a social media platform, means for detecting one or more preferences based on the concept information, means for generating a matrix based on the detected one or more preferences, means for calculating a first similarity between the one or more preferences associated with a first user and one or more preferences associated with a second user based on the generated matrix, and means for generating a recommendation based on the matrix and the calculated first similarity.

### BRIEF DESCRIPTION OF THE DRAWINGS

Exemplary implementation(s) of the present invention will be described in detail based on the following figures, wherein:

FIG. 1 illustrates a flowchart of a process for generating recommendations according to an example implementation of the present application.

FIG. 2 illustrates concept feature extraction from visual content according to an example implementation of the present application.

FIG. 3 illustrates concept feature based interest extraction according to an example implementation of the present application.

FIG. 4 illustrates collaborative filtering using a user-item matrix that may be used in combination with example implementations of the present application.

FIG. 5 illustrates histograms of Spearman's rho of different example implementations of the present application.

FIG. 6 illustrates a social media environment according to an example implementation of the present application.

FIG. 7 illustrates an example computing environment with an example computer device suitable for use in some example implementations.

### DETAILED DESCRIPTION

The following detailed description provides further details of the figures and example implementations of the present application. Reference numerals and descriptions of redundant elements between figures may be omitted for clarity. Terms used throughout the description are provided as examples and are not intended to be limiting. For example, the use of the term “automatic” may involve fully automatic or semi-automatic implementations involving user or operator control over certain aspects of the implementation, depending on the desired implementation of one of ordinary skill in the art of practicing implementations of the present application.

In this modern social media environment, it may not be unusual for a recommender system to have access to be able identify or even access a user's social media identifier (e.g., handle, user name or other identifying information). Many dedicated, visual-centric social networks have been developed in recent years (e.g., INSTAGRAM, SNAPCHAT, TUMBLR, PATH). Some observers have asserted that the growth of these visual-centric social networks indicates a movement away from traditional social networks (such as FACEBOOK, for example). Further, some social networks that started out largely as a text-based (e.g., microblog service TWITTER) have transitioned to now support visual content such as image and video tweets. Such visual content can express significantly more information than simple text-based postings (e.g., photos, videos and other visual content may be worth several words (if not a thousand words)). Further, growth of smartphone usage has made posting photos, videos and other visual content much easier and, in some cases advantageous, compared to typing.

Additionally, the content of photos, videos, and other visual content may positively correlate with, or be representative of, a user's preferences or interests. Thus, photos, video, and other visual content may reveal useful information regarding the interests or preferences of a user. In example implementations of the present application, a recommender system may analyze the social media visual content (e.g., content from photos, videos, drawings, or illustrations) and incorporate the visual content into the recommendation process. Further, in some example implementations, tag, label, or caption content, which may often be associated with posted visual content, may also be used to improve the correlation between posted visual content and a person's true interests. In some example implementations, the visual content of a user's photos, videos, drawings, etc., and tags or labels associated therewith may be used for user-content based recommendation.

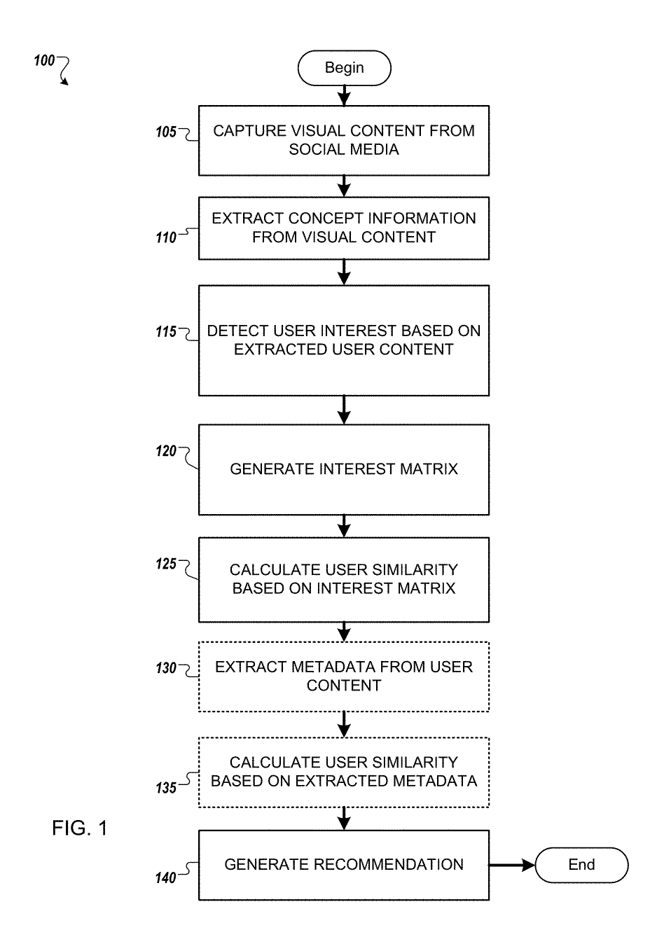

FIG. 1 illustrates a flowchart of a process 100 for generating recommendations according to an example implementation of the present application. In the process 100, a system according to an example implementation first captures visual content (e.g., photos, videos, drawings, illustrations, etc.) associated with a user from one or more social media accounts at 105. In some example implementations, the obtained visual content may be publicly available visual content that the user has shared. In other example implementations, the obtained visual content may be private visual content the user has allowed the system to access. The type of social media account is not particularly limited, and may include any type of social media account that may be associated with visual content that may be apparent to a person of ordinary skill in the art. For example, the social media account may be an account associated with a microblog platform (e.g. Twitter, Instagram, or Tencent Weibo), or any other type of social media platform that may be apparent to a person of ordinary skill in the art.

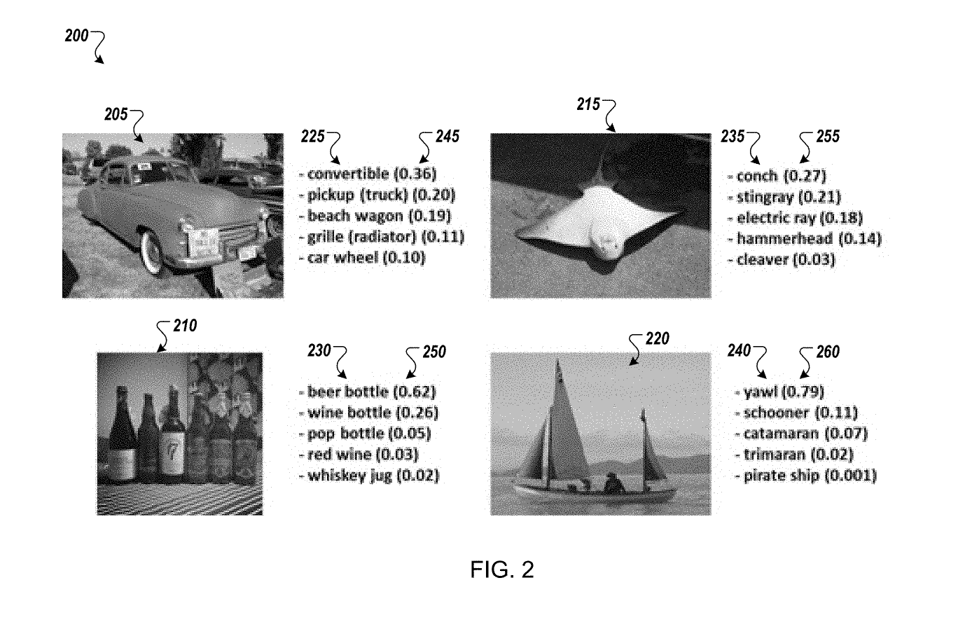

After the visual content is captured, concept information is extracted from the visual content at 110. In some example implementations, the concept information may be extracted from the visual content using image recognition or machine learning techniques to extract visual features from visual content. In some of these example implementations, a deep learning-based image classification and annotation framework may be used to discover and extract concepts in a user's images. For example, a deep-learning computer vision platform such as Caffé, or other similar platforms may be used to extract concepts from the images. Typically deep learning systems use convolutional neural network (CNN) models to construct classifiers for different concepts (using image data). When a new image is provided, it is compared against different classifiers leading to generation of classification scores that are used for final concept labeling. FIG. 2 discussed below provides an example of concept feature extraction from visual content (e.g., concept classes and corresponding scores that could be extracted from example images using a deep-learning computer vision platform) according to an example implementation of the present application.

Based on the extracted concept information (e.g., the concept classes and corresponding scores), user interest is detected at 115. In some example implementations, a user interest feature vector matrix encoding the distribution of different visual concepts (as concept classifier scores) can be computed based on the extracted concept classes and scores using average scores across all images of the user at 120. In the absence of any other information, computing average scores across all images of the user is a reasonable estimate of user interests. For example, a user who takes a lot of photos of dogs is likely to be interested in dogs. The same user may have non-dog photos in their social media collection too. However the averaging operation acts as a filter and only concepts that are visually salient receive good average scores (when taken across all photos).

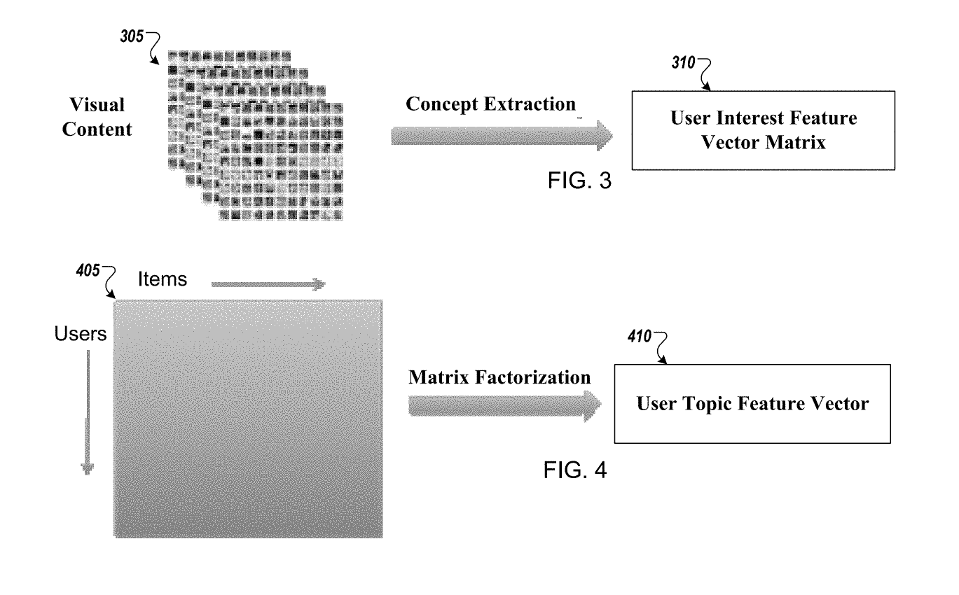

In some example implementations, a plurality of user interest feature vector matrices may be created with one user interest feature vector matrix being created for each user of a social media platform based on the visual content associated with each user. FIG. 3 discussed below illustrates concept feature based interest extraction according to an example implementation of the present application.

Based on the generated interest vector matrix, user similarity may be calculated at 125. Specifically, a rank (r) of an item (i) that may potentially be recommended (e.g., a product, movie, TV show, social group, etc.) with respect to a user x may be computed based on the generated interest matrix using the equation below.

$${r}_{{x}_{i}} = \frac{{\sum }_{y ε {N}_{x}} {S}_{xy} {r}_{{y}_{i}}}{{\sum }_{y ε {N}_{x}} {S}_{xy}} \qquad ( Equation 1 )$$

Nₓ represents the neighborhood of user x (e.g., user y), who have ranked items similar to how the user x has ranked the same items and r_{yi} represents a ranking of the item (i) that has been assigned by other users (e.g., user y). In some example implementations, the ranking by other users (e.g., user y) may also be determined based on a generated interest vector matrix generated for the other users (e.g., y) based on visual content associated with each of the other users.

Further in Equation 1, S_{xy} represents a similarity of interests between users x and y based on concept information extracted from visual content. In some example implementations, cosine similarity may be used as a preferred method for computing similarity S_{xy} of user feature vectors. The similarity S_{xy} may be computed using a low rank representation method used in related art collaborative filtering based on explicit ranking or scoring of items by the user (using the traditional user-item matrix). However, in example implementations of the present application, explicit ranking by the user may not be required because the generated interest vector matrix may be used to identify user x's interests in 125. By using the generated interest vector matrix, the cold-start problem associated with new users having a very sparse user-item matrix may be addressed.

Additionally, in some example implementations, metadata associated with the visual content associated with the user may optionally be extracted at 130. For example, social media visual content may include tags or labels assigned by either visual content owner/users, third party users, or even automatically by a social media platform. For example, a user (either content owner or a third party) or the social media platform may assign captions, tags, or other metadata to the visual content, which may be extracted.

Further, in some example implementations, the extracted metadata may also include Global Positioning System (GPS) information, geotag information, or other location-indicating information associated with the visual content may be extracted. Additionally, an increasing proportion of social media content is being geotagged (in the form of raw GPS data or as check-ins at different venues). Further, many such check-in locations also include business category information associated with them. This information may also be incorporated into the extracted metadata. For example, location specific features may be extracted and incorporated into a vector containing proportions of different business venue categories that a user has visited or checked in at to be used to make recommendations. Further, in some example implementations, potential venues of social media posts that do not have an explicit check-in may be extracted (e.g., implicitly) from other metadata associated with visual content as may be apparent to a person of ordinary skill in the art.

The extracted metadata may be encoded as textual characteristics of the user using a standard information retrieval term frequency inverse document frequency (tf-idf) methodology or any other textual characteristic extraction methodology that may be apparent to a person of ordinary skill in the art. For example, tags, captions, or labels from each user's photos can be aggregated into a synthetic document to construct a textual interest signature as a tf-idf based score vector across the vocabulary of words extracted from the tags, captions, or labels at 130.

Further, the constructed tf-idf based score vector may optionally be used to also calculate user similarity based on the extracted metadata at 135. Again, a rank (r) of an item (i) that may potentially be recommended (e.g., a product, movie, tv show, social group, etc.) with respect to the user x may be computed based on the constructed tf-idf based score vector again using equation 1 (reproduced again below).

$${r}_{{x}_{i}} = \frac{{\sum }_{y ε {N}_{x}} {S}_{xy} {r}_{{y}_{i}}}{{\sum }_{y ε {N}_{x}} {S}_{xy}} \qquad ( Equation 1 )$$

Nₓ represents the neighborhood or user x (e.g., user y), who have ranked items similar to how the user x has ranked the same items and r_{yi} represents a ranking of the item (i) that has been assigned by other users (e.g., user y). At 135, S_{xy} in equation 1 represents a similarity of interests between users x and y calculated using constructed tf-idf based score vector extracted from metadata associated with visual content. In some example implementations, cosine similarity may be used as a method for computing similarity S_{xy} of user feature vectors. Again, the similarity S_{xy} may be computed using a low rank representation methodology.

Thus, in some example implementations of the present application, two similarity matrices may be independently calculated (e.g., one similarity matrix calculated based on concept information from visual content and one calculated based on a constructed tf-idf based score vector extracted from metadata). In such example implementations, these similarity matrices may then be combined into a single matrix using a confidence based linear combination approach or any other methodology that may be apparent to a person of ordinary skill in the art during 135.

At 140, recommendations may be generated based on the ranks calculated using either the combined matrix produced during 135 or the interest matrix based user similarity matrix produced during 125 (in example implementations where metadata is not extracted). Specifically, items receiving a high rank may be recommended and items receiving a low rank may not be recommended and may be discarded. Once the recommendations are provided at 140, the process 100 may end.

In some example implementations, the recommendation process 100 of FIG. 1 may be used independent of any other recommendation frameworks (e.g., for new users with insufficient entries in their particular row of the related art user-item matrix). In other example implementations, the recommendation process 100 of FIG. 1 may be in combination with a related art collaborative filtering user-user similarity matrix methodology (such as illustrated in FIG. 4).

The related art collaborative filtering systems attempt to model user interests implicitly through explicit ranking or based on historical selections by the user. Conversely, the recommendation process 100 models user interests based on user-content similarity. These separate similarity modeling processes may complement each other in some example implementations.

FIG. 2 illustrates concept feature extraction from visual content 200 according to an example implementation of the present application. The concept feature extraction illustrated in FIG. 2 may be performed during a recommendation process such as the process 100 illustrated in FIG. 1 and discussed above. As illustrated, the visual content 200 includes four photos 205-220 that have been posted or shared on a social media platform by a user. However, the visual content 200 is not limited to photos 205-220, and may also include video, drawings, illustrations, or any other visual content that may be apparent to a person of ordinary skill in the art.

From each photo 205-220, concept information may be extracted using image recognition or machine learning techniques to extract visual features from visual content 200. In some example implementations, a deep learning-based image classification and annotation framework may be used to discover and extract concepts in a user's images. For example, a deep-learning computer vision platform such as Caffé, or other similar platforms may be used to extract concepts from the images.

As illustrated, several concept classes 225-240 have been extracted from each photo 205-220, respectively, and corresponding scores 245-260 have been assigned to each concept classes 225-240. The corresponding scores 245-260 represent a likelihood or confidence that the identified concept classes 225-240 correspond to concepts illustrated in the visual content 200 (e.g., the photos 205-220). For example, concept classes 225 (e.g., “convertible”, “pickup (truck)”, “beach wagon”, “grille (radiator)” and “car wheel”) have been extracted from photo 205 and the concept classes 225 have been assigned corresponding scores 245 (e.g., “0.36”, “0.20”, “0.19”, “0.11” and “0.10”) by a deep-learning computer vision platform. Further, concept classes 230 (e.g., “beer bottle”, “wine bottle”, “pop bottle”, “red wine” and “whiskey jug”) have been extracted from photo 210 and the concept classes 230 have been assigned corresponding scores 250 (e.g., “0.62”, “0.26”, “0.05”, “0.03” and “0.02”) by a deep-learning computer vision platform.

Additionally, concept classes 235 (e.g., “conch”, “stingray”, “electric ray”, “hammerhead” and “cleaver”) have been extracted from photo 215 and the concept classes 235 have been assigned corresponding scores 255 (e.g., “0.27”, “0.21”, “0.18”, “0.14” and “0.03”) by a deep-learning computer vision platform. Further, concept classes 240 (e.g., “yawl”, “schooner”, “catamaran”, “trimaran” and “pirate ship”) have been extracted from photo 220 and the concept classes 240 have been assigned corresponding scores 260 (e.g., “0.79”, “0.11”, “0.07”, “0.02” and “0.001”) by a deep-learning computer vision platform. The extracted concept classes 225-240 and the calculated scores 245-260 associated with each photo may be used to detect user interest and generate an interest feature vector matrix as discussed above (e.g., 115 and 120 of process 100 of FIG. 1).

FIG. 3 illustrates concept feature based interest extraction according to an example implementation of the present application. The concept feature based interest extraction illustrated in FIG. 3 may be performed during a recommendation process such as the process 100 illustrated in FIG. 1 and discussed above. As illustrated, a user's visual content collection 305 is analyzed to detect or extract concept features. As discussed above, the visual content collection 305 may include photos, videos, drawings, illustrations, or any other visual content that may be apparent to a person of ordinary skill in the art.

In some example implementations, the concept features may be extracted from each piece of the visual content collection 305 using image recognition or machine learning techniques to extract visual features from the visual content collection 305. In some example implementations, a deep learning-based image classification and annotation framework may be used to discover and extract concepts in a user's images. For example, a deep-learning computer vision platform such as Caffé, or other similar platforms may be used to extract concepts from the images. As discussed above, the extracted concept features include concept classes extracted from each photo and corresponding scores assigned to each extracted concept class. All of the concept classes and corresponding scores for each of the pieces of visual content may be combined to encode the distribution of visual concepts as a user interest feature vector matrix 310 that may be used to calculate a user similarity as discussed above (e.g., 125 of process 100 of FIG. 1).

FIG. 4 illustrates collaborative filtering using a user-item matrix 405 that may be used in combination with example implementations of the present application. For example, collaborative filtering based on a user-item matrix 405 may be used in combination with a recommendation process based on interests extracted from user content such as the process 100 illustrated in FIG. 1 and discussed above. As illustrated, a user-item matrix 405 is used to generate a user topic feature vector 410. The user-item matrix 405 may represent how different users (illustrated along a vertical axis) have numerically ranked various items (along the horizontal axis). The rankings of the items by the different users may be determined by explicit ranking by each user or may be determined based on past selections (e.g., viewing, readings, purchasing, etc.) by each user. The user topic feature vector 410 may be calculated by applying matrix factorization to the user-item matrix 405.

### Example Evaluation

To evaluate various example implementations, the association between a social media user's visual content and their interests was analyzed. A total of approximately 2000 users with approximately 1.2 million photos were analyzed. The visual content of photos was analyzed using state-of-the-art deep learning based automatic concept recognition. For each user, an aggregated visual concept signature was calculated. User tags that had been manually applied to the photos were also used to construct a tf-idf based signature for each user. Additionally, social groups that users belonged to were also obtained to represent the user's social interests.

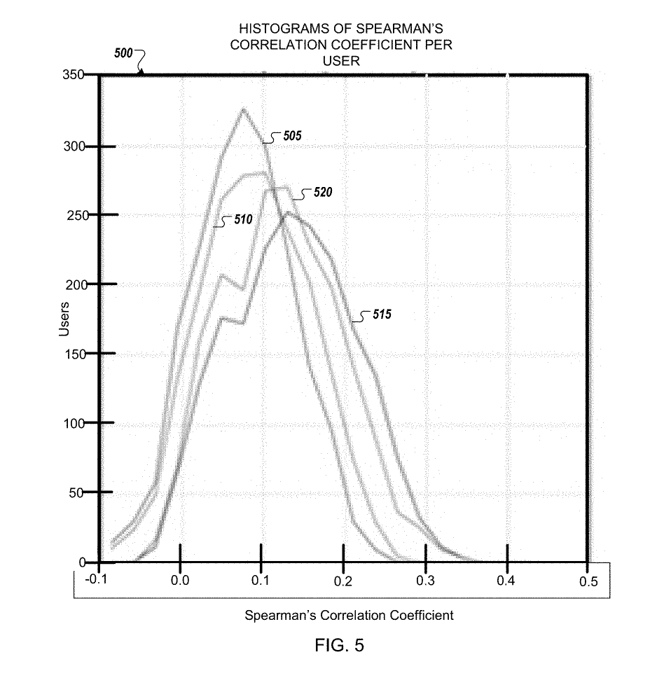

The utility of the visual analysis of various example implementations was validated against a reference inter-user similarity using the Spearman rank correlation coefficient. FIG. 5 illustrates a histogram 500 of Spearman's rank correlation coefficient values calculated between example implementations of the present application. In the histogram 500, plot 505 illustrates the Spearman's rank correlation coefficient values for an example implementation using visual content features alone to make recommendations. Further, plot 510 illustrates the Spearman's rank correlation coefficient values for an example implementation using visual content and user tag information additively combined to make recommendations. Additionally, plot 515 illustrates the Spearman's rank correlation coefficient values for an example implementation using visual content and user tag information multiplicatively combined to make recommendations. Plot 520 illustrates the Spearman's rank correlation coefficient values for an example implementation using user tag information alone to make recommendations.

As illustrated by plot 515, by multiplicatively combining visual and tag based, more users achieve higher values of Spearman's rank correlation coefficient, signifying that visual and tag content together may achieve improved modeling of user interests compared to either single modality. Plot 515 may illustrate a correlation between user photos user interests. Thus, a user associated visual-content based recommendation approach as described herein may provide improved modeling of user interests.

### Example Environment

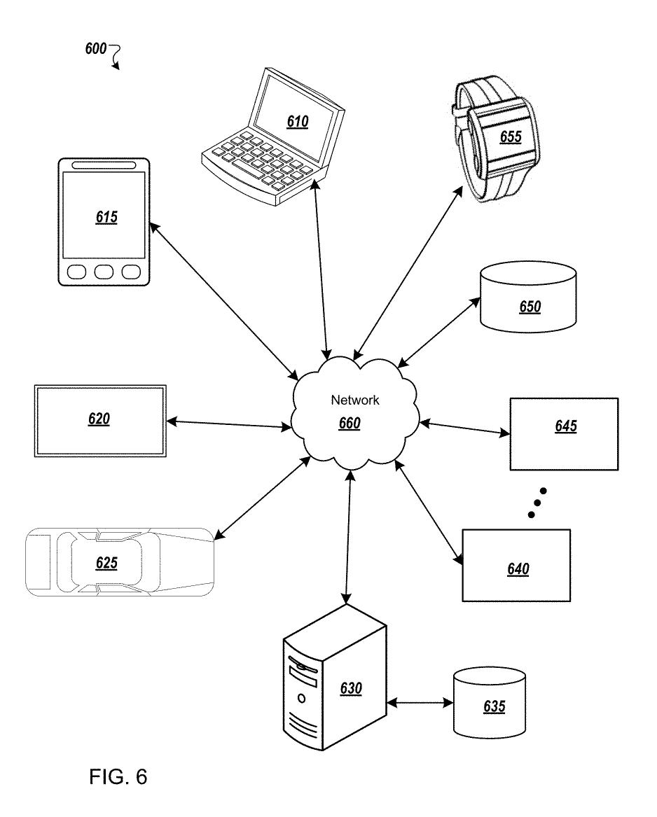

FIG. 6 illustrates an example environment 600 suitable for some example implementations. Environment 600 includes devices 610-655, and each is communicatively connected to at least one other device via, for example, network 660 (e.g., by wired and/or wireless connections). Some devices 630 may be communicatively connected to one or more storage devices 635 and 650.

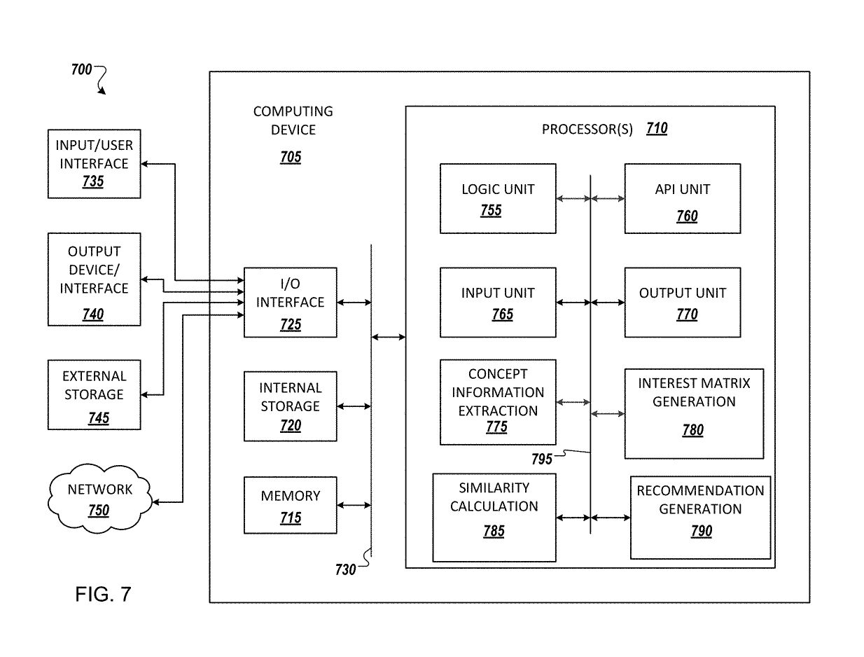

An example of one or more devices 610-655 may be a computing device 705 described below in FIG. 7. Devices 610-655 may include, but are not limited to, a computer 610 (e.g., a laptop computing device), a mobile device 615 (e.g., smartphone or tablet), a television 620, a device associated with a vehicle 625, a server computer 630, computing devices 640-645, storage devices 635 and 650 and wearable device 655.

In some implementations, devices 610-625 and 655 may be considered user devices (e.g., devices used by users to access a social media platform and post or share visual content such as photos, videos, drawings, and illustrations). Devices 630-650 may be devices associated with a recommender system and may be used to extract user interests from the posted visual content and provide recommendations to users.

FIG. 7 illustrates an example computing environment 700 that could be used for remote synchronous meeting with an example computing device 705 suitable for use in some example implementations. Computing device 705 in computing environment 700 can include one or more processing units, cores, or processors 710, memory 715 (e.g., RAM, ROM, and/or the like), internal storage 720 (e.g., magnetic, optical, solid state storage, and/or organic), and/or I/O interface 725, any of which can be coupled on a communication mechanism or bus 730 for communicating information or embedded in the computing device 705.

Computing device 705 can be communicatively coupled to input/user interface 735 and output device/interface 740. Either one or both of input/user interface 735 and output device/interface 740 can be a wired or wireless interface and can be detachable. Input/user interface 735 may include any device, component, sensor, or interface, physical or virtual, which can be used to provide input (e.g., buttons, touch-screen interface, keyboard, a pointing/cursor control, microphone, camera, braille, motion sensor, optical reader, and/or the like). Output device/interface 740 may include a display, television, monitor, printer, speaker, braille, or the like. In some example implementations, input/user interface 735 and output device/interface 740 can be embedded with or physically coupled to the computing device 705. In other example implementations, other computing devices may function as or provide the functions of input/user interface 735 and output device/interface 740 for a computing device 705.

Examples of computing device 705 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, server devices, other computers, information kiosks, televisions with one or more processors embedded therein and/or coupled thereto, radios, and the like).

Computing device 705 can be communicatively coupled (e.g., via I/O interface 725) to external storage 745 and network 750 for communicating with any number of networked components, devices, and systems, including one or more computing devices of the same or different configuration. Computing device 705 or any connected computing device can be functioning as, providing services of, or referred to as a server, client, thin server, general machine, special-purpose machine, or another label.

I/O interface 725 can include, but is not limited to, wired and/or wireless interfaces using any communication or I/O protocols or standards (e.g., Ethernet, 802.11x, Universal System Bus, WiMAX, modem, a cellular network protocol, and the like) for communicating information to and/or from at least all the connected components, devices, and network in computing environment 700. Network 750 can be any network or combination of networks (e.g., the Internet, local area network, wide area network, a telephonic network, a cellular network, satellite network, and the like).

Computing device 705 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computing device 705 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 710 can execute under any operating system (OS) (not shown), in a native or virtual environment. One or more applications can be deployed that include logic unit 755, application programming interface (API) unit 760, input unit 765, output unit 770, concept information extraction unit 775, interest matrix generation unit 780, relative similarity calculation unit 785, recommendation unit 790, and inter-unit communication mechanism 795 for the different units to communicate with each other, with the OS, and with other applications (not shown). For example, concept information extraction unit 775, interest matrix generation unit 780, relative similarity calculation unit 785, and recommendation generation unit 790 may implement one or more processes shown in FIG. 1. The described units and elements can be varied in design, function, configuration, or implementation and are not limited to the descriptions provided.

In some example implementations, when information or an execution instruction is received by API unit 760, it may be communicated to one or more other units (e.g., logic unit 755, input unit 765, output unit 770, concept information extraction unit 775, interest matrix generation unit 780, relative similarity calculation unit 785, and recommendation generation unit 790). For example, the concept information extraction unit 775 may extract concept information from visual content and send the extracted concept information to the interest matrix generation unit 780 to generate an interest matrix. Additionally, the generated interest matrix may be communicated to the similarity calculation unit 785 to be used to calculate user similarity. Further, the recommendation generation unit 790 may generate recommendations based on the calculated user similarity received from the similarity calculation unit 785.

In some instances, the logic unit 755 may be configured to control the information flow among the units and direct the services provided by API unit 760, input unit 765, output unit 770, concept information extraction unit 775, interest matrix generation unit 780, relative similarity calculation unit 785, and recommendation generation unit 790 in some example implementations described above. For example, the flow of one or more processes or implementations may be controlled by logic unit 755 alone or in conjunction with API unit 760.

Although a few example implementations have been shown and described, these example implementations are provided to convey the subject matter described herein to people who are familiar with this field. It should be understood that the subject matter described herein may be implemented in various forms without being limited to the described example implementations. The subject matter described herein can be practiced without those specifically defined or described matters or with other or different elements or matters not described. It will be appreciated by those familiar with this field that changes may be made in these example implementations without departing from the subject matter described herein as defined in the appended claims and their equivalents.

We claim:

1. A method of generating recommendations, the method comprising:
extracting concept information from visual content associated with content posted to a social media platform;
detecting one or more preferences based on the extracted concept information;
generating a matrix based on the detected one or more preferences;
calculating a first similarity between the one or more preferences associated with a first user and one or more preferences associated with a second user based on the generated matrix; and
generating a recommendation based on the matrix and the calculated first similarity.

2. The method of claim 1, further comprising:
extracting metadata associated with the visual content associated with the content posted to the social media platform; and
calculating a second similarity between the first user and the second user based on the extracted metadata associated with the visual content,
wherein the recommendation is generated based on the matrix, the first similarity, and the second similarity.

3. The method of claim 2, wherein the extracting metadata associated with the visual content comprises detecting one or more tags associated with the visual content.

4. The method of claim 2, wherein the extracting metadata associated with the visual content comprises detecting Global Position System (GPS) information associated with capture of the visual content.

5. The method of claim 1, wherein the extracting the concept information comprises detecting visual features in the visual content associated with the content posted to the social media platform.

6. The method of claim 5, wherein the detecting visual features in the visual content comprises applying an image recognition process to the visual content.

7. The method of claim 6, wherein the applying an image recognition process to the visual content comprises applying machine learning to the visual content.

8. The method of claim 1, wherein the visual content includes one or more of a photo, a video, a drawing, and an illustration.

9. The method of claim 1, wherein the second user is at least one other user having at least one preference similar to the first user.

10. The method of claim 1, wherein the second user is at least one other user in the neighborhood of the first user.

11. A non-transitory computer readable medium having stored therein a program for making a computer execute a method of generating recommendations, the method comprising:
extracting concept information from visual content associated with content posted to a social media platform;
detecting one or more preferences based on the extracted concept information;
generating a matrix based on the detected one or more preferences;
calculating a first similarity between the one or more preferences associated with a first user and one or more preferences associated with a second user based on the generated matrix; and
generating a recommendation based on the matrix and the calculated first similarity.

12. The non-transitory computer readable medium of claim 11, further comprising:
extracting metadata associated with the visual content associated with the content posted to the social media platform; and
calculating a second similarity between the first user and the second user based on the extracted metadata associated with the visual content,
wherein the recommendation is generated based on the matrix, the first similarity, and the second similarity.

13. The non-transitory computer readable medium of claim 12, wherein the extracting metadata associated with the visual content comprises detecting one or more tags associated with the visual content.

14. The non-transitory computer readable medium of claim 11, wherein the extracting the concept information comprises detecting visual features in the visual content associated with the content posted to the social media platform.

15. The non-transitory computer readable medium of claim 14, wherein the detecting visual features in the visual content comprises applying an image recognition process to the visual content.

16. The non-transitory computer readable medium of claim 15, wherein the applying an image recognition process to the visual content comprises applying machine learning to the visual content.

17. A server apparatus comprising:
a memory storing content posted to a social media platform;
a processor executing a process comprising:
extracting concept information from visual content associated with content posted to a social media platform;
detecting one or more preferences based on the concept information;
generating a matrix based on the detected one or more preferences;
calculating a first similarity between the one or more preferences associated with a first user and one or more preferences associated with a second user based on the generated matrix; and
generating a recommendation based on the matrix and the calculated first similarity.

18. The server apparatus of claim 17, wherein the processor wherein the processor further executes the process comprising:
extracting metadata associated with the visual content associated with the content posted to the social media platform; and
calculating a second similarity between the user and the second user based on the extracted metadata associated with the visual content, and
wherein the recommendation is generated based on the matrix, the first similarity and the second similarity.

19. The server apparatus of claim 18, wherein the extracting metadata associated with the visual content comprises detecting one or more tags associated with the visual content.

20. The server apparatus of claim 15, wherein the extracting the concept information comprises detecting visual features in the visual content associated with the content posted to the social media platform.

21. The server apparatus of claim 20, wherein the detecting visual features in the visual content comprises applying an image recognition process to the visual content.

22. The server apparatus of claim 21, wherein the applying an image recognition process to the visual content comprises applying machine learning to the visual content.
